(19) United States
(12) Patent Application Publication
(10) Pub. No.: US 2025/0258836 A1
(43) Pub. Date: Aug. 14, 2025

(54) AUDIT TRACKING AND METADATA-BASED DATA SKIPPING IN DATA PROCESSING PIPELINES

(71) Applicant: HONEYWELL INTERNATIONAL INC., Charlotte, NC (US)

(72) Inventor: Bhabesh Acharya, Bangalore (IN)

(21) Appl. No.: 18/632,468

(22) Filed: Apr. 11, 2024

(30) Foreign Application Priority Data
Feb. 9, 2024 (IN) 202411008824

(51) Int. Cl. G06F 16/25

(52) U.S. Cl. CPC G06F 16/254; G06F 16/2282; G06F 16/313

(57) ABSTRACT

The present disclosure provides a method and system for monitoring and managing data processing pipelines that processes data related to industrial assets in an industrial environment. The method comprises audit tracking a plurality of data processing pipelines which comprises the steps of receiving a request for processing at least one asset data in relation to one or more assets within an industrial enterprise. The method comprises processing the at least one asset data for at least one asset type by performing the extract, transform, load (ETL) process. The method further comprises generating an audit table to store starting offset and ending offset for the at least one asset type that has been processed. The method further comprises adding a new record in the audit table, wherein the ending offset for the at least one asset type from the previous run of the ETL process is retrieved and stored as the starting offset for the subsequent run of the ETL process.

### TECHNICAL FIELD

Embodiments of the present disclosure generally relate to monitoring data processing pipelines that processes data related to industrial assets in an industrial environment. Particularly, the present disclosure relates to a method and system for audit tracking data processing pipelines and enabling metadata-based data skipping in data pipelines.

### BACKGROUND

In data warehousing applications, enterprise data from multiple heterogenous sources are collected, stored and organized into a single data repository. The data emanating from multiple data sources may be structured, semi-structured or unstructured and may be in a format different from what is needed in a target data repository. Typically, data-driven business organizations store and handle large amounts of data, which are analyzed in real-time and near real-time for better decision making and enhanced customer experience. The data that is organized into the unified data repository aids in querying, analysis and enables informed business decisions.

An industrial environment, for example, may generally include physical assets such as sensors, industrial equipment, factory equipment, one or more conveyor belts, one or more vehicle components, one or more hearing, ventilation and air conditioning (HVAC) components, machines, computing devices, and various other types of industrial assets. Such assets collect and generate different types of data related to industrial processes within an industrial environment. An enterprise typically manages large amounts of asset data across several sites, buildings and locations. The data thus obtained from such industrial processes may be output in a raw streaming format. This data from multiple disparate data sources needs to be formatted and stored in a unified data repository to facilitate business intelligence (BI). Some functions of BI technologies include reporting, online analytical processing (OLAP), analytics, data mining, business performance management, text mining, and predictive analytics. One goal of BI is for example, to support better business decision-making. Therefore, tools for BI enable, among other things, dynamic querying of real-time data and historical data.

In many BI applications, data processing pipelines play an important role in cleansing the data before ingesting into the target data repository. The data processing pipelines are essential in managing and transforming data as they move from the source to the target data repository. BI tools such as the ETL (Extract, Transform, Load) and ELT (Extract, Load, Transform) are the most common types of data processing pipelines. The data processing pipelines can be used a beneficial tool in the creation and management of efficient and consistent databases, data marts and data warehouses. For example, in any business organization, metrics are collected to assess performance. The process involves raw data collection, aggregation, analysis, presentation and tracking actual performance metrics against target metrics. ETL tools are used for extracting raw data from the source, cleansing the data to remove anomalies and formatting the data to make it suitable for business analytics.

Current data warehouse architectures commonly utilize ETL or ELT processes. The choice of the pipelines depends on the nature of data, data processing constraints and the goals of the business organization. The ETL tools extract the data in raw format, transform the extracted data based on business needs and load the transformed data into the target system providing business enterprises with meaningful and actionable insights. Data-driven business enterprises rely on the use of large volumes of data and different types of data for business operation and insights.

As there are large volumes of data emanating from heterogenous sources, which are conceptualized, cleansed and processed during the ETL process, there is an inherent need to keep audit of the process to ensure consistency and quality of data. There is also a need to leverage metadata collected during the ETL process to improve performance of accessing data by inhibiting unnecessary calls to data stores.

The prior art technologies fail to provide an efficient monitoring mechanism for data processing pipelines which enhances the capabilities of tracking data read as well as providing a mechanism by which unnecessary reading of data can be avoided, thereby reducing the computational resources and increasing the operational efficiency of the data pipelines.

Applicant has identified many technical challenges and difficulties associated with current solutions and through applied effort, ingenuity, and innovation, the applicant has provided a solution to the above-mentioned drawbacks.

### SUMMARY OF THE INVENTION

In general, embodiments of the present disclosure herein provide a method and system for monitoring data processing pipelines that processes data related to industrial assets in an industrial environment. Other implementations will be, or will become, apparent to one with skill in the art upon examination of the following figures and detailed description. It is intended that all such additional implementations be included within this description be within the scope of the disclosure and be protected within the scope of the following claims.

In one embodiment, the present disclosure provides a method for monitoring data processing pipelines that processes data related to industrial assets in an industrial environment. The method comprises audit tracking a plurality of data processing pipelines which comprises the steps of receiving a request for processing at least one asset data in relation to one or more assets within an industrial enterprise. The method comprises processing the at least one asset data for at least one asset type by performing the extract, transform, load (ETL) process. The method further comprises generating an audit table to store starting offset and ending offset for the at least one asset type that has been processed. The method further comprises adding a new record in the audit table, wherein the ending offset for the at least one asset type from the previous run of the ETL process is retrieved and stored as the starting offset for the subsequent run of the ETL process.

In another embodiment, the present disclosure provides a system for audit tracking a plurality of data processing pipelines. The system comprises a processor and memory storing program instructions which, when executed by the processor, causes the processor to receive a request for processing at least one asset data in relation to one or more assets within an industrial enterprise. The system is configured to process the at least one asset data for at least one asset type by performing the extract, transform, load (ETL) process. The system is further configured to generate an audit table to store starting offset and ending offset for the at least one asset type that has been processed and add a new record in the audit table, wherein the ending offset for the at least one asset type from the previous run of the ETL process is retrieved and stored as the starting offset for the subsequent run of the ETL process.

In yet another embodiment, the present disclosure provides a computer program product comprising at least one non-transitory computer-readable storage medium having computer-readable program code portions stored therein executed by a processor, the computer-readable medium when executed, is configured to receive a request for processing at least one asset data in relation to one or more assets within an industrial enterprise. The program executed by the processor is configured to process the at least one asset data for at least one asset type by performing the extract, transform, load (ETL) process. The program executed by the processor is further configured to generate an audit table to store starting offset and ending offset for the at least one asset type that has been processed and add a new record in the audit table, wherein the ending offset for the at least one asset type from the previous run of the ETL process is retrieved and stored as the starting offset for the subsequent run of the ETL process.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary block diagram of an environment, in which embodiments of the present disclosure may operate;

FIG. 2 is an exemplary block diagram of an exemplary Extract, Transform, Load (ETL) system in accordance with one or more embodiments described herein;

FIG. 3 is a block diagram illustrating an exemplary ETL data monitoring system, in accordance with one or more embodiments described herein;

FIG. 4 is another block diagram illustrating an exemplary ETL data monitoring system, in accordance with one or more embodiments described herein;

FIG. 5 illustrates an exemplary block diagram of a method for audit tracking data processing pipelines in accordance with one or more embodiments described herein;

FIG. 6 illustrates an exemplary block diagram of a method for managing data processing pipelines in accordance with one or more embodiments described herein;

### DETAILED DESCRIPTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

Generally, an industrial environment may include physical assets such as sensors, industrial equipment, factory equipment, one or more conveyer belts, one or more vehicle components, one or more HVAC components, machines, computing devices, and various other types of industrial assets. Such assets are configured to generate various types of data related to industrial processes. Further, the assets gather operational data from industrial machinery and monitor key aspects of industrial environment. Sensors, for example may be configured to capture various types of data associated with a premises, building, site, industrial plant or process, manufacturing plant or the like. The data thus obtained from such industrial processes may be output in a raw streaming format or at desired time intervals.

Data-driven business enterprises rely on the use of large volumes of data and different types of data for business operation and insights. For example, every enterprise typically creates its own customized data warehouse or logical data structure that is unique or specific to their organizational needs using well-known relational database management systems (RDBMS). The users or customers of the enterprise (on-premise or in the cloud) may add or use new custom fields in source systems and may want to use the custom fields for reporting metrics in their data warehouse. As source systems and data warehouses move to the cloud, the data needs to be integrated seamlessly into the target system to ensure data quality, data consistency and to load data that is free of errors and anomalies.

To manage the ecosystem for a business enterprise, critical data is collected and aggregated from diverse business applications before storing into a single data repository for various consumers. The data processing pipelines play an important role in online analytical processing (OLAP) by organizing and analyzing the data related to the one or more industrial processes. OLAP describes technologies that can extract and present data for analytics. Analytics aid enterprises to understand the various activities of their business which may include performing contextual analysis, performance management, forecasting, Key Performance Indicators (KPIs) and trends analysis, dash-boarding, and the like. For example, OLAP databases can be used to identify sales trends, analyze marketing campaigns, and forecast financial performance. The process involves evaluating analytical queries against millions of records of data. For example, sales data can be analyzed in terms of dimensions such as time, geographical region, department, and individual products.

The data processing pipelines such as ETL or ELT pipelines aid in contextualizing the raw streaming data based on business needs before loading into the unified target repository. While some data formats may be structured, some other data formats may provide semi-structured or unstructured data schemas. As large amounts of such data may be received from different enterprises and/or assets, contextualization, cleansing and processing of data becomes a complex task. For example, each incoming input data to the data processing pipeline may have unique data properties, characteristics and attributes depending upon the asset and/or asset type, which needs to be formatted to suit the target system.

As extensible data types are complex, dynamic and heterogenous, large amount of contextualization and cleansing from source format to the target format may be required before storage. At times, during the integration process, failures in the pipelines can result in scenarios where data is not loaded or loaded incorrectly into the target system. There could also be scenarios which result in incomplete and inaccurate data being loaded hampering the use of data for Business intelligence. There could also be scenarios where the target system does not have the expected number of loads or the quality of data may be compromised.

Therefore, there is a need for a mechanism to effectively monitor and audit the data processing pipelines by enhancing key capabilities of tracking data read as well a mechanism by which queries can avoid reading unnecessary data.

There is also a need to provide an auditing mechanism that helps to maintain the integrity of ETL process by eliminating errors and anomalies and tracing the dynamic changes to the data moved from the source system to the target system.

It is also desirable to manage the data processing pipelines by storing metadata that gives pointers to queries thereby enhancing query performance and inhibiting unnecessary calls to data stores, which in turn would be beneficial in improving performance of accessing data. Monitoring the dynamic changes to the data during integration would be helpful in providing robust information in the form of metadata which would aid in data validation and end-user customization.

There is yet another need to provide an effective ETL data monitoring and management system that provides high levels of data quality and provides metrics for assessing improvements in the data quality of a business organization.

Accordingly, the present disclosure provides a method, system and computer program product for tracking and managing data processing pipelines for enabling refined read performance and preventing unnecessary calls to the data stores.

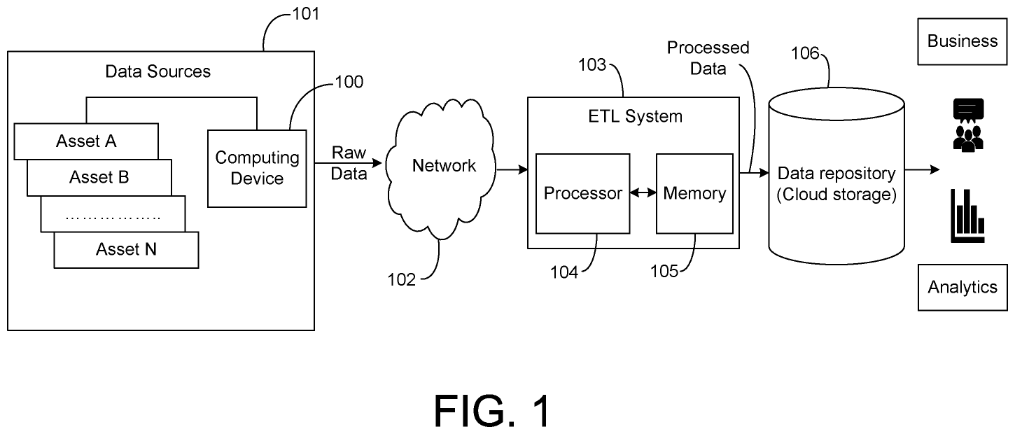

FIG. 1 illustrates an exemplary block diagram of an environment, in which the embodiments of the present disclosure may operate. Specifically, FIG. 1 illustrates one or computing devices 100. In some embodiments, one or computing devices 100 may be associated with one or more data sources 101. The one or more data sources 101 in some embodiments, may include one or more assets, Asset A, Asset B, Asset N related to one or more industrial enterprises in an industrial environment. In some embodiments, the one or more assets may be associated with any entity or facility including but not limited to companies, buildings, industrial plants, manufacturing plants, warehouses, real estate facilities, laboratories, aircraft, spacecraft, automobiles, vehicles, sites, premises, or any other type of entity in an industrial environment. In some embodiments, one or more computing devices 100 and the one or more data sources 101 and/or assets may be associated with a tenant or user group and/or domain. The tenant may own one or more data sources 101 and/or assets.

According to various embodiments, a network 102 is configured to provide communication between various components depicted in FIG. 1. In some embodiments, the network 102 includes a public network (e.g., the Internet), (e.g., an internal localized, or closed-off network between particular devices). In some other embodiments, the network 102 may be a hybrid network (e.g., a network enabling internal communications between particular connected devices and external communications with other devices). Such configuration(s) include, without limitation, a wired or wireless Personal Area Network (PAN), a Cloud network, Local Area Network (LAN), Metropolitan Area Network (MAN), Wide Area Network (WAN), and/or the like. In various embodiments, the network 102 may include one or more base station(s), relay(s), router(s), switch(es), routing station(s), and/or the like.

In some embodiments, the one or more computing devices 100 is configured via hardware, software, firmware, and/or a combination thereof to receive one or more types of data associated with one or more assets. In various embodiments, one or more computing devices 100 is configured to receive operational data in relation to one or more assets. In some embodiments, the one or more computing devices 100 may receive operational data from one or more sensors associated with one or more assets or data sources 101. The operational data may comprise sensor data or any other data describing operation of the one or more assets. In one or more embodiments, the operational data may define the type of sensors associated with an asset and the type of data that is being sensed by each sensor. For example, the sensor data received from one or more computing devices 100 may comprise data received from one or more heat sensors, gas sensors, humidity sensors, pressure sensors, temperature sensors, and the like. In one example, the sensors may monitor the operation of a residential or commercial building or enterprise (e.g., security systems, building automation systems, and the like). In another example, the sensors may monitor the operation of a manufacturing plant (e.g., manufacturing machinery, conveyor belts, and the like). In another example, the sensors may control or monitor the operation of a vehicle. In some embodiments, the data in relation to assets may be called asset data.

Typically, a given enterprise may manage operations of various assets (e.g., possibly thousands) across several sites and locations. Management of such systems often includes monitoring the operations of the assets and controlling the assets to optimize the performance of the assets and accomplish specific business objectives of the enterprise. For example, managing the operations of the assets may include aggregating contextual data defining various attributes such as relationships, types, locations associated with the assets. This aggregated context data may be collected and stored to provide actionable insights for management of various assets of the business enterprise.

According to various embodiments, one or more sensors may monitor one or more operational and performance metrics of the assets. In some embodiments, the sensors may be located remotely or in proximity of the assets. The sensors may be utilized to collect data associated with an asset in real-time or at one or more pre-defined intervals (e.g., every 5 minutes, hourly, and the like). In one example, a temperature sensor may include real-time temperature data associated with one or more assets. For example, a thermostat may monitor the temperature of a building environment to control the functions of an installed HVAC system in order to maintain a set temperature within the building environment. Humidity sensors, for example may capture the amount of water vapor in a particular system. Pressure sensors, for example may detect the fluctuations or drops in pressure for systems that include gases and liquids.

In an embodiment, the sensor data or operational data are received from various assets, premises, building, site, location, space, industrial plant or process, laboratory, manufacturing plant or process, vehicle, and/or utility plant or process, etc. In some embodiments, sensors may be configured to capture values associated with a premises, building, site, location, industrial plant or process, laboratory, manufacturing plant or process, and/or utility plant or process, or operations associated therewith. Such sensor data and operational data associated with the operations of different data entities may comprise meta data associated with various components and assets, defining various attributes and characteristics of the asset and relationships between the assets. In one implementation, the operational data may describe parameters, characteristics, attributes, and relationships associated with the one or more assets forming a knowledge domain. In one example, the knowledge domain may be represented as an ontology model providing information regarding the characteristics of data emanating from multiple assets. The ontology model may provide a representation of the one or more assets, classification of the assets into different types, definition of various attributes of the assets and definition of relationships between the various assets and categories. In an embodiment, the data may include identification information and type information of the assets, properties associated with the identification information and the type information, physical locations of the assets, relationships between the assets with respect to each other, relationships between types of the assets with respect to each other, etc.

In one embodiment, an Extract, Transform, Load (ETL) system 103 of FIG. 1 may receive data from one or more computing devices 100 in relation to one or more assets through the network 102. In one or more embodiments, the one or more computing devices 100 is integrated within or corresponds to a mobile computing device, a smartphone, a tablet computer, a mobile computer, a desktop computer, a laptop computer, a workstation computer, a wearable device, a virtual reality device, an augmented reality device, or another type of remote computing device.

The data received by the ETL system 103 from the one or more computing devices 100 may be in a raw streaming format in some embodiments. For example, many data-driven organizations within the industrial environment may process large volume of data which may be diverse in type and formats. The raw streaming data may include for example, industrial asset data related to one or more industrial processes such as asset configuration data, asset identification data, sensor identification data, sensor data, site data, real-time data, operational data, fault data to name a few examples. In one or more embodiments, the sensor data includes real-time sensor data and historical sensor data. In one or more embodiments, the site data includes but not limited to specific site data for an asset infrastructure, event data for an asset infrastructure, process data for an asset infrastructure, operational data for an asset infrastructure, fault data for an asset infrastructure. In certain embodiments, the one or more computing devices 100 incorporates encryption capabilities to facilitate encryption of one or more portions of the received industrial asset data.

According to some embodiments, the raw streaming data from the one or more computing devices 100 needs to be processed to render them useful and conform to the format of the target data repository 106 for actionable insights. In some embodiments, the target data repository 106 may be one or more databases or data lakes or data warehouses based on the business requirements of the business enterprise. In certain embodiments, the database or data lake may be a time series database which can be configured to store one or more portions of raw streaming data and formatted asset data.

According to various embodiments, the ETL system 103 may include a processor 104 and a memory 105 for storing and executing instructions to facilitate processing of the raw data. For example, the raw data is extracted and transformed by the ETL system 103 to remove anomalies, duplicates, errors before ingestion into a target cloud repository 106 for storage, reporting, analysis and decision making. Such data can be used by industrial enterprises for performing business related operations, such as data mining, OLAP, and decision support. Accordingly, in one or more embodiments, the ETL system 103 may include one or more software modules or components to facilitate data processing in accordance with the one or more embodiments of the present disclosure.

The memory 105 may be non-transitory and may include, for example, one or more volatile and/or non-volatile memories. In some embodiments, the memory 105 includes or embodies an electronic storage device (e.g., a computer readable storage medium). In some embodiments, the memory 105 is configured to store information, data, content, applications, instructions, or the like, for enabling a system to carry out various operations and/or functions in accordance with example embodiments of the present disclosure.

In an embodiment, one or more modules (not shown) of the ETL system 103 may be implemented using electronic hardware, computer software, or any combination thereof. Whether such elements are implemented as hardware or software depends upon the application and design constraints imposed on the overall system. Examples of the systems may include computing systems (e.g., servers, datacenters, desktop computers, Internet of Things devices, etc.) and mobile computing systems (e.g., laptops, cell phones, etc.). Although components are described with respect to functional limitations, it should be understood that the particular implementations necessarily include the use of particular computing hardware. It should also be understood that in some embodiments certain of the components described herein include similar or common hardware.

In one preferred embodiment, the ETL system 103 of the present disclosure may be configured as a cloud-based system.

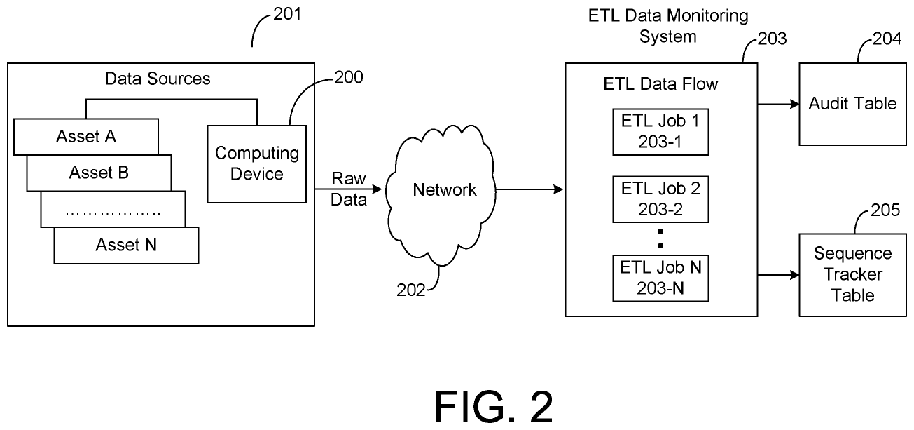

The ETL system 103, in one or more embodiments may be an ETL data monitoring system, 203, in accordance with the embodiments of the present disclosure which is described in greater detail in FIG. 2.

FIG. 2 illustrates an ETL data monitoring system 203 that is one embodiment of ETL system 103 of FIG. 1. In an embodiment, the ETL data monitoring system 203 may comprise one or more modules for extracting and contextualizing data received from one or more assets (e.g. sensor data) received from one or from one or more computing devices 200 (100 of FIG. 1) from one or more data sources and/or assets, 201 (101 of FIG. 1) within one or more industrial enterprises. According to various embodiments, a network 202 (102 of FIG. 1) may be configured to provide communication between various components depicted in FIG. 2. In one implementation, the system 203 performs an Extract, Transform, Load (ETL) process where the raw data is extracted from source systems, transformed before loading into a target repository. As the data is in its original form, it has to be transformed and mapped to prepare for the target data repository. In the transformation phase, the ETL validates, authenticates, deduplicates, aggregates the data to enable data querying. In another implementation, the system 203 is an Extract, Load, transform (ELT) process where the raw data is extracted and loaded into the target system, where the data transformation takes place. ETL and ELT are types of data integration pipelines which cleanses the raw data from the one or more assets, contextualizes the data by applying business rules and calculations and integrates the data for accuracy and consistency with the target data repository. Thus, “ETL” can be replaced with “ELT” in all instances without deviating from the intent of the disclosure.

In an embodiment, the ETL data monitoring system 203 receives data from one or more computing devices 200 associated with one or more assets from one or more industrial enterprises. In some embodiments, the data may be received from one or more sensors associated with one or more assets operating within the industrial environment. The sensor data may be received in streaming formats or at pre-defined intervals, according to various embodiments herein.

Typically, large amounts of such sensor data may be received from different enterprises and/or assets, and the data contextualization requirements vary from asset to asset based on the business requirements of the particular industry. For example, each incoming input data to the data processing pipeline may have unique data properties, characteristics and attributes depending upon the asset and/or asset type. Moreover, as data is not static, new data sources are added and existing data sets change as business requirements keep evolving. Sometimes old information is rewritten by adding new data, in other instances history and audit of the changes to data may need to be logged.

Therefore, the ETL processes are complex and require a significant amount of processing time. Also, a lot of effort is involved in running the data processing pipelines as it processes several hundreds and thousands of records. The ETL processes may also involve errors that can halt the data integration process. Therefore, to ensure that the ETL process is complete, they need to be scheduled, monitored, logged and audited. Logging the data changes and having an effective audit mechanism can minimize any disruption in the data migration or integration process. The audit logs, for example, can include information about execution time, status information, success or failure of load process, the errors encountered during the process, etc.

The audit mechanism should also be able to leverage the operational metadata collected by the ETL processes. Storing metadata that gives pointers to queries enhances query performance and inhibits unnecessary calls to data stores, which in turn would be beneficial in improving performance of data processing tasks. The metadata-based data skipping helps in skipping redundant data leading to faster query execution and reduction in the usage of computer resources and costs. Logging and auditing further aids in identifying errors and optimizing the resources and performance of the data pipelines. An effective auditing mechanism will help in ensuring data quality in case of issues related to duplicate, missing or inconsistent data. Therefore, the data processing pipeline needs to be managed and audited effectively to accommodate varying requirements for each asset and/or enterprise at the same time ensuring high quality, accuracy, completeness, consistency and integrity of data.

To this end, the ETL data monitoring system 203 of FIG. 2 may be configured to perform a plurality of extract, transform, load (ETL) processes, also referred to as ETL jobs in some embodiments. According to some embodiments, the ETL Job 1 203-1, ETL Job 2 203-2, ETL Job N, 203-N may be configured to extract data records from multiple sources, transform the data records into a target format, and load the data records into a data repository. For example, the raw data is extracted and transformed to remove anomalies, duplicates, errors before ingestion into a target cloud repository for storage, reporting, analysis and decision making. Such data can be used by industrial enterprises for performing business related operations, such as data mining, OLAP, and decision support.

In some embodiments, the ETL data monitoring system 203 may be configured to manage and monitor data extracted by the ETL jobs, ETL Job 1 203-1, ETL Job 2 203-2, ETL Job N 203-N. According to some embodiments, the data is obtained from a plurality of different sources and assets comprising smart devices, sensors, enterprise systems, or Internet sources having different software interfaces. In some embodiments, the data is persisted in data stores and comprises structured data, unstructured data, time-series data and relational data to name a few examples. In some examples, the processing performed on the sensor data may be based at least in part on sensor metadata associated with a sensor.

According to some embodiments, the ETL data monitoring system 203 generates audit log of the ETL jobs and manages and analyses the extracted log data. In some embodiments, the audit log also referred to as the audit table, 204 measures and evaluates the ETL processes by tracking metrics such as the volume of data, quality of data records, data lineage, data accuracy, completeness, etc. Thus, according to some embodiments, the audit table 204 tracks metrics such as the amount of data that is extracted and loaded into the target repository, the correctness of the data loaded, and quality of data loaded into the target system. The audit table 204 will also help in producing data lineage by providing a platform where the sources of input, output and transforms including data/tables are traced. In some embodiments, the audit table 204, may store the event data and the status information associated with one or more jobs. The event data may include event timestamp, event type, job statistics, status information, a unique job identification information, data volume information, etc. associated with the ETL process. One or more embodiments described herein may also comprise an ETL performance dashboard that provides administrators with information on the performance of ETL processes.

The table below indicates a general schema of the audit table 204 generated after each instance of an ETL job. As can be seen, the audit table may store logs, job statistics and information relating to each instance of ETL process. For example, the attribute, etl_id indicates a unique identification number for each ETL process and attribute etl_name indicates the name for each ETL run. The unique identification number for each ETL run may be an autogenerated primary key indicating an ETL run. The audit table also has attribute etl_start_time which may indicate the timestamp at which the ETL process was triggered or started. Attribute etl_end_time may indicate the time at which the ETL run was successfully completed. While attribute start_event_time reflects the start timestamp of a scheduled event, attribute end_event_time reflects the end timestamp of the event. The attribute etl_estimated_quality estimates the quality of the ETL run based on the number of records expected to be loaded into the target repository. The attribute etl_triggered_by indicates that the ETL process can be triggered by a schedule. For example, the ETL processes can run at pre-defined intervals (e.g., every 20 minutes, hourly, every day of the month, and the like).

| Serial | Attribute | Datatype |
|---|---|---|
| 1 | etl_id | INT |
| 2 | etl_name | NAVARCHAR (50) |
| 3 | etl_start_time | TIMESTAMP |
| 4 | etl_end_time | TIMESTAMP |
| 5 | Start_event_time | TIMESTAMP |
| 6 | End_evert_time | TIMESTAMP |
| 7 | etl_estimated_quality | NAVARCHAR (15) or Double?? |
| 8 | etl_triggered_by | NAVARCHAR (50) |

In one or more embodiments, the audit table 204 generated when one or more ETL jobs 203-1, 203-2, 203N are executed is illustrated below.

| etl_id(PK) | | | | | | etl_{—} | | |
|---|---|---|---|---|---|---|---|---|
| (auto- | | | | | | estimated_{—} | etl_{—} | |
| generated) | etl_name | etl_start_time | etl_end_time | start_event_time | end_event_time | quality | triggered_by | Reconciled |
| 12345 | ETL_1_{—} | [symbol] 24 Apr. 2023 | [symbol] 24 Apr. 2023 | [symbol] 24 Apr. 2023 | [symbol] 24 Apr. 2023 | BAD | Scheduler | NO→YES |
| | 24042023 | 6:00 AM IST | 6:35 AM IST | 00 AM IST | 6:00 AM IST | | | |
| 12389 | ETL_1_{—} | [symbol] 24 Apr. 2023 | [symbol] 24 Apr. 2023 | [symbol] 24 Apr. 2023 | [symbol] 24 Apr. 2023 | GOOD | IF signal | NA |
| | 24042023 | 8:00 AM IST | 8:40 AM IST | 00 AM IST | 6:00 AM IST | | | |

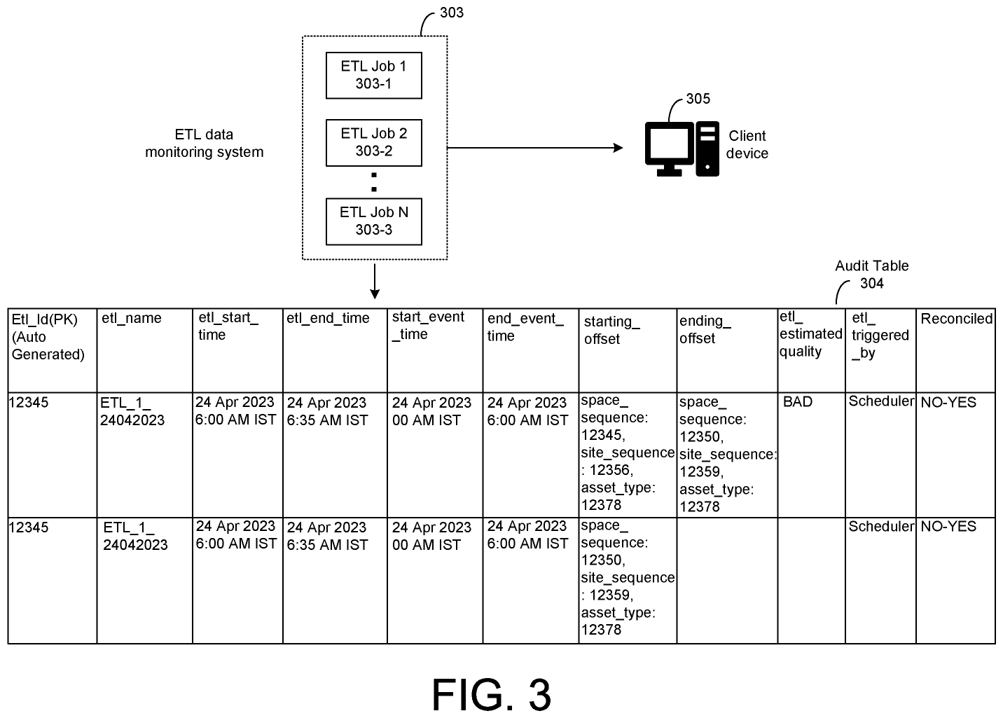

As can be seen from the table above, the etl_id 12345 and etl_id 12389 are examples of unique identification numbers for the ETL jobs. For example, the attribute etl_name indicates the name of the ETL run, which is generated using a combination of the word, ETL, the ETL number of the day and date i.e. ETL_1_24042023. Also, the audit table 204 logs the start and end timestamp of the ETL process, the start and end timestamp of the scheduled events. According to some embodiments, the ETL data monitoring system 203 is configured to log the quality of each ETL job indicated by the attribute, “etl_estimated quality” in the audit table. In an example, for the ETL process indicated by the etl_id 12389, the estimated_quality attribute indicates that the quality of the ETL run is good. In another example, when the quality of the ETL process is determined to be bad, the data monitoring system 203 is configured to log the reconciliation status in the audit table 204 when the desired level of quality is obtained based on pre-determined factors. For example, the attribute “reconciled” indicates that quality of the ETL process was reconciled reflecting the status “YES” for the etl_id 12345. The etl_triggered_by attribute logs information as to whether the ETL is trigged by a scheduler. While FIG. 2 discusses the generation of audit table 204 as part of the data monitoring mechanism in general, FIG. 3 specifically elaborates on how the audit tables are generated for data that is processed from different assets and asset types within one or more industrial enterprises in the context of the present invention.

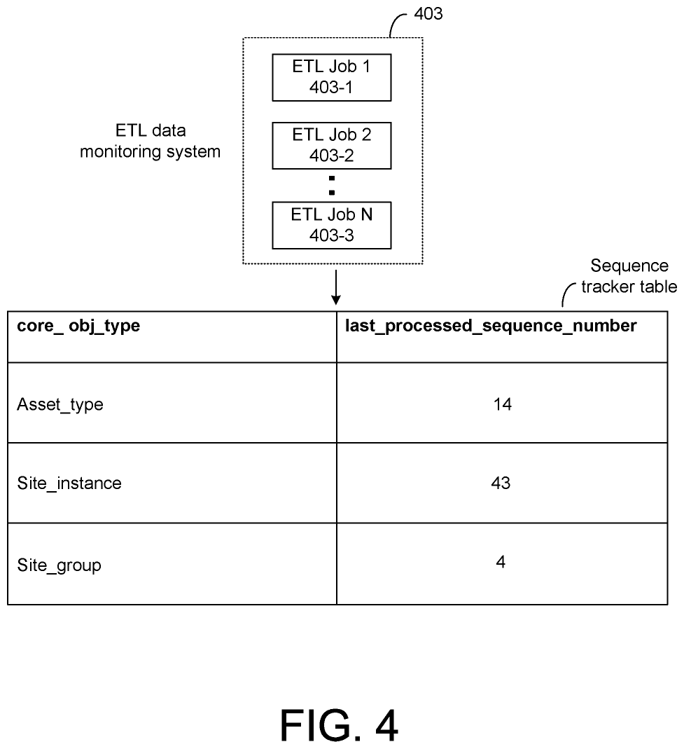

In one or more embodiments, the ETL data monitoring system 203 may also be configured to generate a sequence tracker table 205 as part of the ETL audit mechanism. In an embodiment, the sequence tracker table 205, helps to track the sequence of tasks within one or more ETL jobs, 203-1, 203-2, 203-3. It helps in monitoring the progress of different tasks, identifying the records that have been processed or maintaining a record of order in which the tasks were executed. An exemplary sequence tracker table generated as part of the ETL audit process in accordance with one or more embodiments herein will be discussed in greater detail in FIG. 4.

Although FIG. 2 illustrates the ETL Job 1 203-1, ETL Job 2 203-2, ETL Job N, 203-N, the ETL system 203 may be configured to run a plurality of ETL jobs according to some embodiments.

FIG. 3 illustrates another exemplary block diagram of an ETL data monitoring system 303 (203 of FIG. 2) in accordance with one or more embodiments described herein. In an embodiment, the ETL data monitoring system 303 is configured to generate audit logs to reflect the dynamic changes to the data that is processed by the ETL jobs 303-1, 303-2, 303-N. The ETL data monitoring system 303 is configured to generate audit table 304 to log the data changes during the extraction and loading process. The audit log also referred to as the audit table 304 measures and evaluates the ETL processes by tracking metrics such as the volume of data, quality of data records, data lineage, data accuracy and completeness, etc. Thus, according to some embodiments, the audit table 304 tracks metrics such as the amount of data that is extracted and loaded into the target repository, the correctness of the data loaded, and quality of data loaded into the target system by obtaining information regarding ETL jobs scheduled in the ETL system. In an embodiment, the client device 305 may receive and provide information associated with one or more ETL jobs, the ETL job metrics or status information associated with one or more ETL jobs, and/or anomalies or trends.

In an embodiment, the data monitoring system 303 is configured to audit a plurality of ETL jobs 303-1, 303-2, 303-N, where input data from multiple assets of different industrial enterprises are received, extracted and conceptualized before loading into the target repository. An industrial environment, for example, may generally include physical assets such as sensors, industrial equipment, factory equipment, one or more conveyor belts, one or more vehicle components, one or more hearing, ventilation and air conditioning (HVAC) components, machines, computing devices, and various other types of industrial assets. Such assets collect and generate different types of data related to industrial processes within an industrial environment. An enterprise typically manages large amounts of asset data across several sites, buildings and locations. In an embodiment, the asset data may be sensor data received from different space, sites, assets across various industrial units. In some embodiments, such sensor data, may be received, for example in real time. In some other embodiments, the sensor data, may be received at particular timestamp intervals (e.g., every minute, every 5 minutes, every hour, and/or the like).

In an embodiment, the sensor data or operational data received from various assets, premises, building, site, location, space, industrial plant or process, laboratory, manufacturing plant or process, vehicle, and/or utility plant or process, etc. may comprise metadata. The metadata may be associated with various components and assets, define various attributes and characteristics of the asset and relationships between the assets. In one implementation, the operational data may describe parameters, characteristics, attributes, and relationships associated with the one or more assets forming a knowledge domain. In one example, the knowledge domain may be represented as an ontology model providing information regarding the characteristics of data emanating from multiple assets. The ontology model may provide a representation of the one or more assets, classification of the assets into different types, definition of various attributes of the assets and definition of relationships between the various assets and categories.

According to an embodiment, such sensor data which is received may be processed corresponding to the asset and per asset type (e.g. sites, space, assets, buildings, entities) by performing one or more of the ETL jobs. In an embodiment, the audit of such ETL jobs may include logging of the number of records that have been read during a particular instance of ETL run. The tables below are illustrative examples of the audit table generated for each ETL job. In an example context, for etl_id 12455, the audit table indicates log of the number of records that have been read for the space_sequence, where the starting_offset and ending_offset attribute indicates that offsets 12345 to 12350 have been read during the run of etl_id 12455. The ETL job is triggered by a scheduler as indicated by the etl_triggered_by column.

According to one example, the quality of the ETL job is determined to be bad as indicated in the etl_estimated_quality. For example, the quality of the ETL processes can be determined to be good or bad depending on a number of parameters including the amount of data churned during the ETL run, number of participating devices in the ETL run, number of participating sensors and size of data that is being extracted and loaded. For instance, in the below audit table, the quality of the ETL process 12345 was determined to be bad as indicated by the etl_estimated_quality. The “no” to “yes” status of the reconciled column in the audit table indicates that the quality was reconciled when the quality was determined to be bad. According to some embodiments, the reconciliation of the ETL process is done till a pre-determined quality level is achieved. The desired quality level is estimated based on the number records expected to be loaded for an asset type for a particular time interval (6 hours). For example, the quality status of the ETL process in the audit table is updated when the quality of the ETL process meets a predetermined confidence score. In an example embodiment, the quality of the ETL process may expressed as good/bad based on a confidence score of 9.9/8.7.

| etl_id | | | | | | | | | | |
|---|---|---|---|---|---|---|---|---|---|---|
| (PK) | | | | start_{—} | end_{—} | | | etl_{—} | etl_{—} | |
| (auto- | etl_{—} | etl_start_{—} | etl_end_{—} | event_{—} | event_{—} | starting_{—} | ending_{—} | estimated_{—} | triggered_{—} | |
| generated) | name | time | time | time | time | offset | offset | quality | by | Reconciled |
| 12455 | ETL_1_{—} | [symbol] 24 Apr. | [symbol] 24 Apr. | [symbol] 24 Apr. | [symbol] 24 Apr. | Space | Space | BAD | Scheduler | NO→YES |
| | 24042023 | 2023 | 2023 | 2023 | 2023 | sequence: | sequence: | | | |
| | | 6:00 AM | 6:35 AM | 00 AM | 6:00 AM | 12345, | 12350, | | | |
| | | IST | IST | IST | IST | | | | | |

In an example context, the audit table below indicates log of the number of records that have been read for the site_sequence, where the starting_offset and ending_offset attribute indicates that offsets 12356 to 12359 have been read during a particular ETL run.

| | | | | | | | | | | |
|---|---|---|---|---|---|---|---|---|---|---|
| etl_id(PK) | | etl_{—} | etl_{—} | start_{—} | end_{—} | | | etl_{—} | etl_{—} | |
| (auto- | etl_{—} | start_{—} | end_{—} | event_{—} | event_{—} | starting_{—} | ending_{—} | estimated_{—} | triggered_{—} | |
| generated) | name | time | time | time | time | offset | offset | quality | by | Reconciled |

| | |
|---|---|
| Site | Site |
| sequence: | sequence: |
| 12356, | 12359, |

In yet another example, the audit table below indicates log of the number of records that have been read for the asset_type, where the starting_offset and ending_offset column has been updated as 12378 indicating no records for the particular asset type have been read during the particular ETL run.

| | | | | | | | | | | |
|---|---|---|---|---|---|---|---|---|---|---|
| etl_id(PK) | | etl_{—} | etl_{—} | start_{—} | end_{—} | | | etl_{—} | etl_{—} | |
| (auto- | etl_{—} | start_{—} | end_{—} | event_{—} | event_{—} | starting_{—} | ending_{—} | estimated_{—} | triggered_{—} | |
| generated) | name | time | time | time | time | offset | offset | quality | by | Reconciled |

| | |
|---|---|
| Asset | Asset |
| type: | type: |
| 12378, | 12378, |

As illustrated in the tables above, the ETL data monitoring system 303 may be configured to audit the plurality of ETL jobs and generate logs in the form of audit table reflecting the status of the ETL run for each asset type associated with one or more assets within an industrial environment, wherein the asset data is stored as an ontology model comprising metadata relating to operational aspects of the assets. The metadata may be associated with various components and assets, define various attributes and characteristics of the asset and relationships between the assets. In one implementation, the operational data may describe parameters, characteristics, attributes, and relationships associated with the one or more assets forming a knowledge domain.

In an embodiment, when asset data (sensor data) related to one or more assets is received from the engineering units, the data corresponding to each asset type is processed by one or more ETL jobs. In an embodiment, the ETL data monitoring system 303 logs the starting and ending offsets for each asset type that has been processed in an ETL run by generating an audit table 304. In an embodiment, a new record is added in the audit table 304 by cloning the first record, and wherein for the new record, the ending offset for the at least one asset type (space, site, asset, etc) from the previous run of the ETL process is retrieved and stored as the starting offset for the subsequent run of the ETL process. The audit table 304 thus generated is illustrated in FIG. 3 shown below.

| etl_id | | | | | | | | | | |
|---|---|---|---|---|---|---|---|---|---|---|
| (PK) | | | | start_{—} | end_{—} | | | etl_{—} | etl_{—} | |
| (auto- | etl_{—} | etl_start_{—} | etl_end_{—} | event_{—} | event_{—} | | | estimated | triggered_{—} | |
| generated) | name | time | time | time | time | starting_offset | ending_offset | quality | by | reconciled |
| 12345 | ETL_1_{—} | [symbol] [symbol] Apr. | [symbol] 24 Apr. | [symbol] 24 Apr. | [symbol] 24 Apr. | space_sequence: | space_sequence: | BAD | Scheduler | NO→YES |
| | 24042023 | 2023 | 2023 | 2023 | 2023 | 12345, | 12350, | | | |
| | | 6:00 AM | 6:35 AM | 00 AM | 6:00 AM | site_sequence: | site_sequence: | | | |
| | | IST | IST | IST | IST | 12356, | 12359, | | | |
| | | | | | | asset_type: | asset_type: | | | |
| | | | | | | 12378 | 12378 | | | |
| 12345 | ETL_1_{—} | [symbol] 24 Apr. | [symbol] 24 Apr. | [symbol] 24 Apr. | [symbol] 24 Apr. | space_sequence: | | | Scheduler | NO→YES |
| | 24042023 | 2023 | 2023 | 2023 | 2023 | 12350, | | | | |
| | | [symbol] AM | [symbol] AM | 00 AM | [symbol] AM | site_sequence: | | | | |
| | | IST | IST | IST | IST | 12359, | | | | |
| | | | | | | asset_type: | | | | |
| | | | | | | 12378 | | | | |

[symbol]

indicates data missing or illegible when filed

As can be seen in the audit table generated above, the starting offsets for space_sequence, site_sequence, asset_type have been logged as 12345, 12356, 12378 respectively. The ending offsets for space_sequence, site_sequence, asset_type have been logged as 12350, 12359, 12378 respectively. The logs correspond to etl_id 12345. When the next run of the ETL process is executed, it must copy the ending offsets from the last ETL run. This is to make sure that the new run of the ETL process does not re-process old data thereby eliminating duplicate reads. This is indicated in the second row of the audit table above where the ending offsets from the last run ETL is retrieved and stored as the starting offset for the next run by cloning the first row. As the new ETL run proceeds to completion, it takes a note of the offsets it has been tracking per core object type and persists that into the ending offsets column for that run. This information is again used in the same manner, by the next ETL process in the future (6 hours later, for example). Thus, the audit tables generated for each asset type in this manner would avoid duplicate reads and reduce computational resources.

FIG. 4 illustrates another exemplary block diagram of an ETL data monitoring system 403 (203 of FIG. 2) in accordance with one or more embodiments described herein. In an embodiment, the ETL data monitoring system 403 is configured to generate a sequence tracker table 404 to track the sequence of records that have been processed per core object or asset type. In an embodiment, the sequence tracker table 404 stores the sequence numbers of the last processed record per core object type by the one or more ETL jobs, 403-1, 403-2, 403-N, The sequence tracker table 404 depicted below is an example of the sequence numbers of the records that have been processed. For example, 14, 43 and 4 are the last processed sequence numbers corresponding to the asset_type, site_instance and site_group.

| core_obj_type | last_processed_sequence_number |
|---|---|
| Asset_Type | 14 |
| Site_Instance | 43 |
| Site_group | 4 |

In an embodiment, the ETL data monitoring system 403 is configured to manage and audit a plurality of ETL jobs by generating a sequence tracker table and an audit table. In an embodiment, when asset data (sensor data) related to one or more assets is received from the engineering units, the data corresponding to each asset type is processed by the one or more ETL jobs. In an embodiment, the data monitoring system 403 is configured to generate the audit table reflecting the status of the ETL run for each asset type associated with one or more assets within an industrial environment, wherein the asset data is stored as an ontology model comprising metadata relating to operational aspects of the data. The metadata may be associated with various components and assets, define various attributes and characteristics of the asset and relationships between the assets. In one implementation, the operational data may describe parameters, characteristics, attributes, and relationships associated with the one or more assets forming a knowledge domain.

In an embodiment, the ETL data monitoring system 403 is further configured to generate the audit table to store starting offset and ending offset for the at least one asset type that has been processed. In one or more embodiments, the system 403 is further configured to compare the offset in the sequence tracker table and the audit table. According to some embodiments, the sequence tracker table stores a plurality of sequence numbers for the at least one asset type in relation to one or more assets, wherein the stored sequence number identifies the last processed offset for the core object type. In an embodiment, if the offset in the audit table is greater than the offset in the sequence tracker table, the data monitoring system 403 determines that the data acquisition is complete and no further data processing is required. In an embodiment, if the offset in the audit table is lesser than the offset in the sequence tracker table, the data monitoring system 403 is configured to extract data only with sequence numbers greater than or equal to the offset in the audit table.

Embodiments of the present disclosure thus provide a framework for audit of the the data processing pipelines by avoiding duplicate reads, enhancing performance of accessing data, enabling metadata-based data skipping for refined read performance, improving the quality of data loaded during the ETL process and producing data lineage.

In one or more embodiments, the auditing mechanism can provide robust information in the form of metadata on the industrial assets and corresponding sensors, the engineering units associated with one or more industrial assets, the measurement values captured by the industrial assets and sensors, and the like. The various embodiments disclosed herein can reduce computational resources, and deliver meaningful and useful business insights for analysis of the health, function, efficiency of the industrial assets in a particular industrial environment.

The tracking and audit mechanism of the data processing pipelines enables improved querying that include, but not limited to, data queries regarding the identifying information of industrial assets and corresponding sensors, the locality of the industrial assets and corresponding sensor points, the control functions of the industrial assets and sensor points, the engineering units associated with one or more industrial assets, the measurement values captured by the industrial assets and sensor points, and the like.

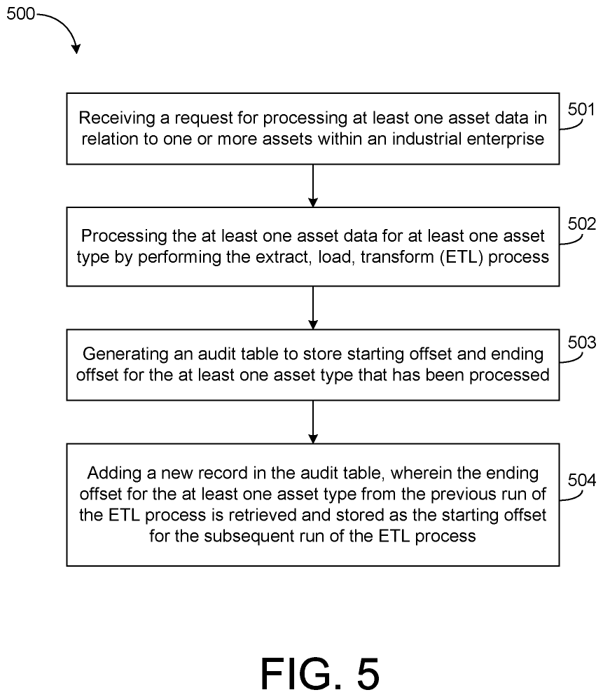

FIG. 5 illustrates an exemplary block diagram of a method for audit tracking data processing pipelines in accordance with one or more embodiments described herein. The method, 500 may be implemented by the ETL data system, 103, 203, 303 as described above in FIG. 3 above. Although the embodiments described herein are in the context of an ETL, the various techniques and components illustrated and described herein may be applied to other database management systems in different embodiments that may facilitate auditing and tracking of data for refined read performance.

The method 500 is illustrated as logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. The order in which the operations are described is not intended to be construed as a limitation, and any number of the described operations can be combined in any order and/or in parallel to implement the method.

The method begins at step 501 wherein data from one or more assets (asset data) from one or more industrial enterprises may be received. In various embodiments, one or more computing devices 200 of FIG. 2 is configured to receive operational data in relation to one or more assets. In some embodiments, the one or more computing devices 100 may receive data from one or more sensors associated with one or more assets. In some embodiments, the data in relation to assets may be called asset data.

At step 502, the asset data received in step 501 is processed for at least one asset type (sites, space, buildings, etc.) by performing the one or more ETL jobs 303-1, 303-2, 303-N. The asset data received from multiple data sources are extracted, cleansed and loaded into the target system. Data cleansing in some embodiments may include removing data inconsistencies, deduplication to discard redundant data records, sorting or ordering to organize the data records according certain criteria, joining data from multiple data sources, aggregating data to summarize multiple rows of data, among other examples.

At step 503, an audit table is generated to store the starting and ending offsets of each asset type that has been processed in step 502. The starting and ending offset column in the audit table indicate the start and end of the records that have been processed during the ETL run.

At step 504, a new record is added in the audit table by cloning the previous record, wherein the ending offset for the at least one asset type from the previous run of the ETL process is retrieved and stored as the starting offset for the subsequent run of the ETL process. When the next run of the ETL process is executed, it must copy the ending offsets from the last ETL run. This is to make sure that the new run of the ETL process does not re-process old data thereby eliminating duplicate reads. This is indicated in the second row of the audit table 304 discussed in FIG. 3 where the ending offsets from the last run of ETL is retrieved and stored as the starting offset for the next run by cloning the first row. As the new ETL run proceeds to completion, it takes a note of the offsets it has been tracking per core object type and persists that into the ending offsets column for that run. This information is again used in the same manner, by the next ETL process in the future (6 hours later, for example). Thus, the audit tables generated for each asset type in this manner would avoid duplicate reads and reduce computational resources.

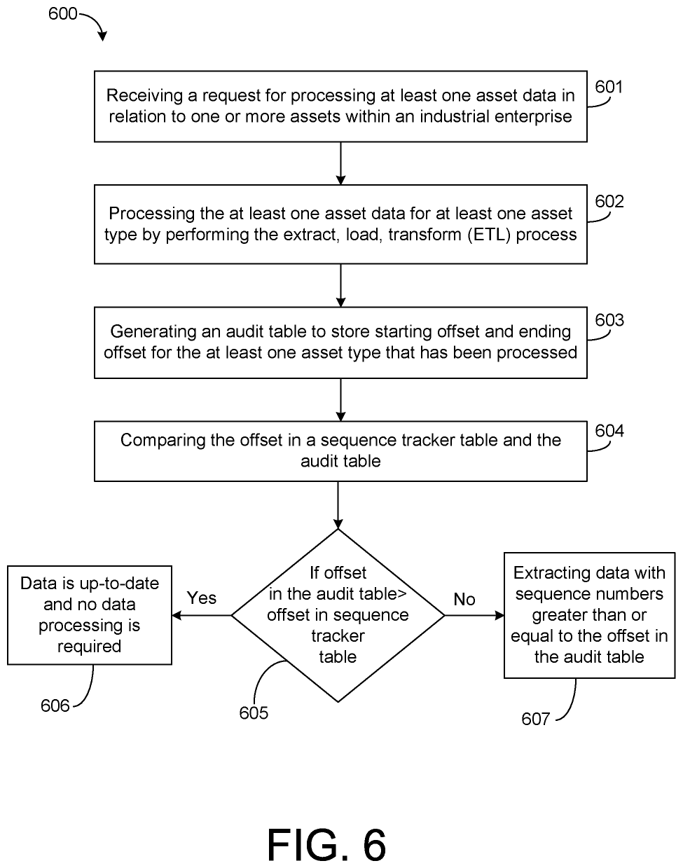

FIG. 6 illustrates an exemplary block diagram of a method for managing data processing pipelines in accordance with one or more embodiments described herein. The method, 600 may be implemented by the data processing system, 303, 403 as described above in FIGS. 2, 3.

The method begins at step 601 wherein data from one or more assets (asset data) from one or more industrial enterprises may be received. In various embodiments, one or more computing devices 200 of FIG. 2 may be configured to receive operational data in relation to one or more assets. In some embodiments, the one or more computing devices 100 may receive data from one or more sensors associated with one or more assets. In some embodiments, the data in relation to assets may be called asset data.

At 602, the asset data received in step 601 is processed for at least one asset type (sites, space, buildings, etc.) by performing the one or more ETL jobs 303-1, 302-2, 303-N, 403-1, 403-2, 403-N. The data processing is performed by the ETL jobs by extracting the raw data from multiple assets, cleansing the data and migrating or integrating the data into the target repository. In some embodiments data cleansing may include removing data inconsistencies, data duplicates, redundant data records, sorting or ordering to organize the data records according to certain criteria, joining the data from multiple data sources, aggregating data to summarize multiple rows of data, among other examples.

At 603, an audit table is generated to store the starting and ending offsets of the asset types that has been processed. The starting and ending offset column in the audit table denote the start and end of the records that have been processed during a particular ETL run.

At 604, the offset in the sequence tracker table is compared to the offset in the audit table. The sequence tracker table 404 generated as part of the ETL audit mechanism helps to track the sequence of tasks within one or more ETL jobs. It helps in monitoring the progress of different tasks, identifying the records that have been processed or maintaining a record of order in which the tasks were executed.

At 605, the method determines as to whether the offset in the audit table is greater than the offset in the sequence tracker table as a result of the comparison of the offsets performed at step 604. In an embodiment, if the offset in the audit table is greater than the offset in the sequence tracker table, the method determines at step 606 that the data acquisition is complete and no further data processing is required. In another embodiment, if the offset in the audit table is lesser than the offset in the sequence tracker table, data with sequence numbers greater than or equal to the offset in the audit table is extracted, processed and loaded into the target data repository at step 607.

According to various embodiments, the audit mechanism according to the various embodiments discussed herein provides refined read performance and enables metadata-based data skipping. Robust logging, auditing and tracking will be helpful in the ETL process for efficient data manipulation and business insights. The method(s) also improves the operational efficiency of the ETL pipelines.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment). The present disclosure intends to include specific reference to all combinations and sub combinations of physically compatible features, components, apparatuses, and processes described herein. As used herein, the term “or” is used in both the alternative and conjunctive sense, unless otherwise indicated. Use of any such aforementioned terms, or similarly interchangeable terms, should not be taken to limit the spirit and scope of embodiments of the present disclosure. As used in the specification and the appended claims. The singular form of “a,” “an,” and “the” include plural references unless otherwise stated. The terms “includes” and/or “including,” when used in the specification, specify the presence of stated features, elements, and/or components, and/or groups thereof.

In an embodiment, the functional units have been labeled as modules, in order to more particularly emphasize their implementation independence. For example, a module may be implemented as a hardware or a software by various types of processors. A module of executable code may, for instance, comprise one or more physical or logical blocks of computer instructions, which may, for instance, be organized as an object, procedure, or function. Nevertheless, the executables of a module need not be physically located together, but may comprise disparate instructions stored in different locations which, when joined logically together, comprise the module and achieve the stated purpose for the module.

In an embodiment, the functional units have been labeled as modules, in order to more particularly emphasize their implementation independence. For example, a module may be implemented as a hardware or a software by various types of processors. A module of executable code may, for instance, comprise one or more physical or logical blocks of computer instructions, which may, for instance, be organized as an object, procedure, or function. Nevertheless, the executables of a module need not be physically located together, but may comprise disparate instructions stored in different locations which, when joined logically together, comprise the module and achieve the stated purpose for the module.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

Processor may be embodied in a number of different ways. In various embodiments, the use of the terms “processor” should be understood to include a single core processor, a multi-core processor, multiple processors and/or one or more remote or “cloud” processor(s). In some example embodiments, processor may include one or more processing devices configured to perform independently. In some embodiments, the processor includes hardware, software, firmware, and/or a combination thereof that performs one or more operations described herein.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments, a storage system or other management entity within the artificial intelligence and machine learning infrastructure may also implement automated training with continuous learning based on new data.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed:

1) A method for audit tracking a plurality of data processing pipelines comprising:
receiving a request for processing at least one asset data in relation to one or more assets within an industrial enterprise;
processing the at least one asset data for at least one asset type by performing the extract, transform, load (ETL) process;
generating an audit table to store starting offset and ending offset for the at least one asset type that has been processed;
adding a new record in the audit table, wherein the ending offset for the at least one asset type from the previous run of the ETL process is retrieved and stored as the starting offset for the subsequent run of the ETL process.

2) The method of claim 1, wherein the ending offset for the at least one asset type is saved for every run of the ETL process.

3) The method of claim 1, wherein the asset data comprises one or more sensor data.

4) The method of claim 1, wherein the audit table comprises metadata for a plurality of ETL processes.

5) The method of claim 1, wherein the audit table comprises data about start and end time of the ETL process, unique name and Identifier for each ETL process.

6) The method of claim 1, further comprising determining the quality of at least one ETL process based on quality criteria such as the number of data records processed during each ETL process, number of participating sensors and size of input asset data during each ETL process.

7) The method of claim 6, further comprising updating the quality status of the ETL process in the audit table based on whether the ETL process meets the quality criteria

8) The method of claim 7, further comprising updating the quality status of the ETL process in the audit table when the quality of the ETL process meets a predetermined confidence score.

9) The method of claim 1, further comprising generating a sequence tracker table to store a plurality of sequence numbers for at least one asset type in relation to the one or more assets within an industrial enterprise, wherein the at least one sequence number identifies the last processed offset for the at least one asset type.

10) The method of claim 9, further comprising comparing the offset in the sequence tracker table and the audit table, wherein if the offset in the audit table is greater than the offset in the sequence tracker table, no data processing is required;
wherein if the offset in the audit table is lesser than the offset in the sequence tracker table, extracting data with sequence numbers greater than or equal to the offset in the audit table.

11) A system for audit tracking a plurality of data processing pipelines comprising:
a processor;
a memory storing program instructions which, when executed by the processor, causes the processor to:
receive a request for processing at least one asset data in relation to one or more assets within an industrial enterprise;
process the at least one asset data for at least one asset type by performing the extract, transform, load (ETL) process;
generate an audit table to store starting offset and ending offset for the at least one asset type that has been processed;
add a new record in the audit table, wherein the ending offset for the at least one asset type from the previous run of the ETL process is retrieved and stored as the starting offset for the subsequent run of the ETL process.

12) The system of claim 11, wherein the ending offset for the at least one asset type is saved for every run of the ETL process.

13) The system of claim 11, wherein the asset data comprises one or more sensor data.

14) The system of claim 11, wherein the audit table comprises data about start and end time of the ETL process, unique name and identifier for each ETL process.

15) The system of claim 11, wherein the quality of at least one ETL process is determined based on quality criteria such as the number of data records processed during each ETL process, number of participating sensors and size of input asset data during each ETL process.

16) The system of claim 15, wherein the quality status in the audit table is updated based on whether the ETL process meets the quality criteria.

17) The system of claim 16, wherein the quality status of the ETL process in the audit table is updated when the quality of the ETL process meets a predetermined confidence score.

18) The system of claim 1, wherein a sequence tracker table is generated to store a plurality of sequence numbers for at least one asset type in relation to the one or more assets within an industrial enterprise, wherein the at least one sequence number identifies the last processed offset for the at least one asset type.

19) The system of claim 9, wherein the processor is configured to compare the offset in the sequence tracker table and the audit table, wherein if the offset in the audit table is greater than the offset in the sequence tracker table, no data processing is required; and
wherein if the offset in the audit table is lesser than the offset in the sequence tracker table, the processor is configured to extract data with sequence numbers greater than or equal to the offset in the audit table.

20) A non-transitory computer-readable storage medium storing program instructions for processing data, the instructions, when executed, perform the steps of:
receiving a request for processing at least one asset data in relation to one or more assets within an industrial enterprise;
processing the at least one asset data for at least one asset type by performing the extract, transform, load (ETL) process;
generating an audit table to store starting offset and ending offset for the at least one asset type that has been processed;
adding a new record in the audit table, wherein the ending offset for the at least one asset type from the previous run of the ETL process is retrieved and stored as the starting offset for the subsequent run of the ETL process.
